(19) United States
(12) Patent Application Publication
(10) Pub. No.: US 2012/0296595 A1
(43) Pub. Date: Nov. 22, 2012

(54) COMPENSATING FOR SPECTRAL DIFFERENCES BETWEEN TWO SPECTROPHOTOMETERS FOR ACCURATE COLOR MANAGEMENT

(75) Inventors: Edul N. DALAL, Webster, NY (US); Lalit Keshav MESTHA, Fairport, NY (US); Wencheng WU, Webster, NY (US)

(73) Assignee: XEROX CORPORATION, Norwalk, CT (US)

(21) Appl. No.: 13/108,544

(22) Filed: May 16, 2011

(51) Int. Cl. G06F 19/00

(52) U.S. Cl. 702/104

(57) ABSTRACT

What is disclosed is a system and method for compensating for differences between two spectrophotometers for accurate color control in a color management system. In one example embodiment, at least one print is generated on the digital color printing system incorporating an inline spectral reflectance measurement sensor. A spectral reflectance of the print is measured using an inline spectral reflectance measurement sensor. Spectral reflectance of the print is measured using a selected offline spectral reflectance measurement sensor. From the measurements, a sensor correction model is determined which transforms spectral measurements obtained from the inline sensor into spectra approximating what the offline sensor would measure. The sensor correction model is used to perform color management on the digital color printing system such that print output of the digital color printing system is accurate when measured on the offline sensor.

### TECHNICAL FIELD

The present invention is directed to systems and methods for accurate color management, by compensating for spectral sensing differences between an inline spectrophotometer used to proof a digital document reproduction device and an offline spectrophotometer used to measure a color sample printed by that device.

### BACKGROUND

One primary goal of a color management system is to effectively reproduce user-specified colors. Spot color calibration is used to accurately reproduce user-specified spot colors. Printer profiling is used to accurately render process colors. These functions become more complicated in an important customer application where the user measures colors from hardcopy samples using an offline spectrophotometer and then wishes to reproduce those colors on a print system device which relies upon inline spectral sensors. This is because, for various practical reasons, it can be difficult or impractical to measure reference samples using the inline instrumentation. For example, in GRACoL certification involving process color accuracy, printer profiling is conducted with inline instrumentation but the resulting color accuracy is necessarily determined by offline instrumentation. The Xerox iGen4 220 Perfecting Press has a dual print engine architecture wherein the two print engines, each with their own ILS (inline spectrophotometer) print on alternate pages. In this case, the problem that is addressed could be the difference between the two inline instruments rather than between an inline and an offline instrument.

Accordingly, what is needed is a method for compensating for spectral differences between a first spectral reflectance measurement sensor used to proof a digital document reproduction device and a second spectral reflectance measurement sensor used to measure color samples printed by that device for accurate color management.

### INCORPORATED REFERENCES

The following U.S. patents, U.S. patent applications, and Publications are incorporated herein in their entirety by reference.
“Method For Conditional Application Of Color Measurement Error Compensation In Spectral Sensors”, U.S. Publication No. 20090296091, by Skinner et al.
“Minimizing Spectrophotometer Impact On Spot Color Accuracy”, U.S. patent application Ser. No. 12/607,212, by Dalal et al.
“Method To Minimize Instrument Differences In Color Management Functions”, U.S. Publication No. 20090009766, by Bonino et al.
“Method And System For Correcting Spectrophotometer Differences”, U.S. Publication No. 20090296074, by Victor R. Klassen.
“Full Width Array Scanning Spectrophotometer”, U.S. Pat. No. 6,975,949, to Mestha et al.
“Spectrophotometer For Color Printer Color Control With Displacement Insensitive Optics”, U.S. Pat. No. 6,384,918, to Hubble III, et al.
“Method And System For Compensating For Thermochromaticity Differences In Inline Spectrophotometers”, U.S. Pat. No. 7,684,082, to Mestha, et al.,
“Graphic Technology—Improving The Inter-Instrument Agreement Of Spectrocolorimeters”, Danny C. Rich, Committee for Graphic Arts Technologies Standards (CGATS), (January 2004).
“Imaging Colorimetry Using a Digital Camera”, W. Wu, J. P. Allebach, and Mostafa Analoui, Journal of Imaging Science and Technology, Vol. 44, No. 4, pp. 267-279, (July/August 2000).
“Measuring Colour”, R. W. G. Hunt, Fountain Press Ltd, 3rd Ed. (2001), ISBN-13: 978-0863433870.

### BRIEF SUMMARY

What is disclosed is a novel system and method for compensating for spectral differences between two spectrophotometers for accurate color management in a digital document reproduction system. Various workflows are provided. Using the methods disclosed herein, differences between two spectral measurement devices can be effectively compensated for and accurate color management achieved with relatively little user effort.

In one example embodiment, the present method for compensating for differences between two spectrophotometers involves performing the following. First, at least one print is generated on the digital color printing system incorporating an inline spectral reflectance measurement sensor. A spectral reflectance of the print is measured using an inline spectral reflectance measurement sensor. Spectral reflectance of the print is measured using a selected offline spectral reflectance measurement sensor. From the measurements, a sensor correction model is determined which transforms spectral measurements obtained from the inline sensor into spectra approximating what the offline sensor would measure. The sensor correction model is used to perform color management on the digital color printing system such that print output of the digital color printing system is accurate when measured on the offline sensor.

Many features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 is an example embodiment of a digital document reproduction system incorporating an inline spectrophotometer;

FIG. 2 is a flow diagram of one example embodiment of the present method for compensating for differences between an inline spectrophotometer used to proof a digital document reproduction device and an offline spectrophotometer used to measure a color sample printed by that device;

FIG. 3 illustrates a block diagram of one example embodiment of a special purpose computer system for performing one or more aspects of the present system and method as described with respect to the example flow diagram of FIG. 2.

FIG. 4 is a top view of one example reflectance sensing device which measures spectral reflectance values of color training samples or “test patches”; and

FIG. 5 is a cross-sectional view of the device shown in FIG. 4.

### DETAILED DESCRIPTION

What is disclosed is a novel system and method for compensating for spectral differences between two sensors to achieve accurate color management in a digital document reproduction system.

It should be understood that one of ordinary skill in this art should be readily familiar with the various aspects of color space, color manipulation, and color rendering on an image output device, including device profiles. Those of ordinary skill in this art would be familiar with the text: “Digital Color Imaging Handbook”, 1st Ed., CRC Press (2003), ISBN-13: 97808-4930-9007, and “Control of Color Imaging Systems: Analysis and Design”, CRC Press (2009), ISBN-13: 97808-4933-7468, both of which are incorporated herein in their entirety by reference.

### NON-LIMITING DEFINITIONS

A “spectral reflectance value”, usually given as R(λ), is a representation of the reflectance factor R as a function of wavelength λ. Reflectance factor R is the fraction of incident light which is reflected by the sample of interest, relative to some normalizing condition, typically a perfect diffuse reflector. Spectral reflectance values are obtained using a reflectance sensing device which samples a reflectance stimulus at different wavelengths.

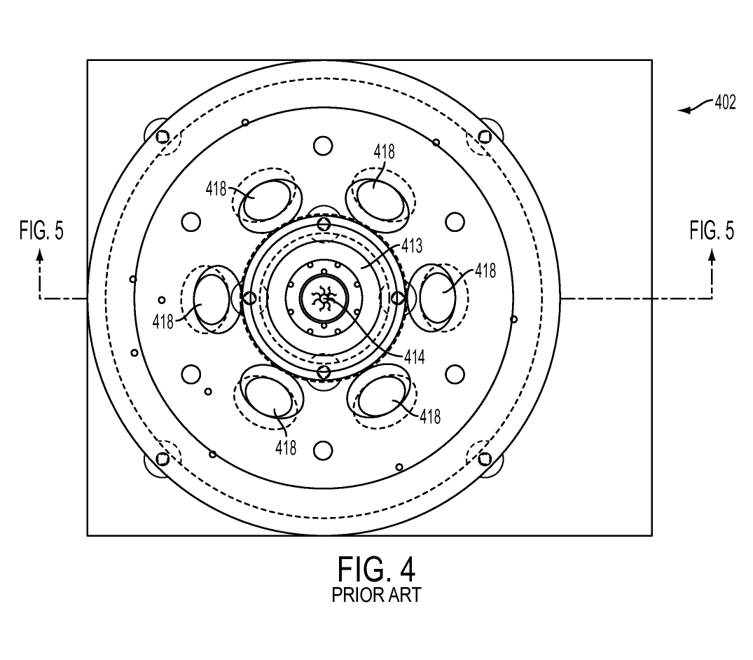

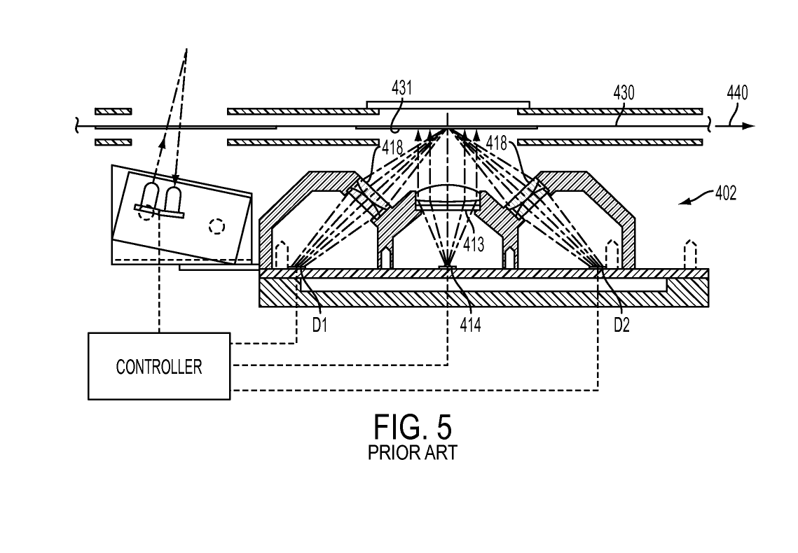

A “spectral reflectance measurement sensor” or “spectrophotometer” is a sensor used for measuring spectral reflectance values of a sample, such as, for instance, a printed color test patch. The output of a spectrophotometer may be, for example, distinct electrical signals corresponding to the different levels of reflected light from the respective different illumination wavelength ranges over multiple channels. A given spectrophotometric device may comprise illuminators of different colors or a single broadband illuminator source with a monochromator or a set of color filters. The monochromator or set of color filters may be applied either to the incident illumination or to the reflected illumination. In one embodiment, the illuminators of a given device are switched on/off in a predetermined sequence such that spectral measurements can be obtained in each illuminator's wavelength range. Terms such as photosensors, photo-cells, detectors, and sensors are used interchangeably. Each is capable of generating an output electrical signal in response to receiving a reflected light. A multiple LED spectrophotometer may be considered to belong to a class of spectrophotometers which illuminate a target with narrow band or monochromatic light. Flashed Xenon lamp spectrophotometers, and QH spectrophotometers utilized wide band illumination sources. One example spectrophotometer having 8 illuminators is shown and discussed with respect to FIGS. 4 and 5.

An “inline spectral reflectance measurement sensor” is a spectrophotometer which is typically positioned in the paper output path subsequent to the marking engine and prior to a finisher downstream of the print engine.

A “spot color” refers to any color generated by a single ink which can be printed as a single separation. Spot colors are often used for color critical areas such as, for instance, large background areas or a company logo. Spot color classification systems include: Pantone®, Toyo, DIC, ANPA, GCMI, and HKS.

A “spot color recipe” defines a combination of process colors (e.g., CMYK or CMYKOV) which can be used to emulate a spot color. In a 4-color CMYK system, Gray Component Replacement (GCR) is a strategy used to replace an appropriate amount of C, M and Y with an equivalent amount of K. Spot colors in an N-color printing system (N≧4) are typically rendered with a particular GCR strategy since some colors can be rendered by any of several different recipes.

A “sensor correction model” transforms spectral measurements obtained from a first sensor into a spectrum approximating what a second sensor would measure. The sensor correction model may be used to perform color management on a digital print system. One example use of the sensor correction model is to determine a set of color definitions in a color space of the digital document reproduction device. The color definitions are such that, when color test patches are printed by that digital document reproduction device and measured using the second sensor, differences between the target reflectance spectra and spectral measurements from the second sensor are within a predetermined level of acceptability.

A “set of color definitions” refers to the amounts of each of the primary colorants (inks or toners) required to produce a given color when printed by the digital document reproduction device. In a typical 4-color reproduction device, these would correspond to the C, M, Y, K values.

A “digital document reproduction device” refers to a wide variety of digital imaging system architectures which includes monochrome or color devices, digital printing presses, and other multi-function document reproduction systems. Such systems generally include a display device such as a CRT or touch screen along with one or more user interfaces such as a keyboard, mouse, keypad, touchpad, and the like, for entering data and configuring device-specific settings to optimize image quality and performance. One of ordinary skill would readily appreciate that various device components internal to a particular document reproduction system can be changed, modified, or otherwise configured by a user and/or in response to a signal from device controllers to compensate for any color measurement differences given the attributes of a particular print media selected for a given print/copy job. For example, the amount of toner to be applied to a particular print media surface can be adjusted, and the temperature at which toner is fused to the surface of a particular type of print media. Complex print system devices have many such components capable of being configured. In many print system devices, device settings can be changed through a user interface on the device, to ensure accurate color rendition. Such complex devices further incorporate a color management system which is a hardware or software system (or sub-system) which receives color signals of an input image, applies an amount of color correction to the input signals, and outputs processed signals to the device such that colors are accurately reproduced.

### GENERAL DISCUSSION

As stated in the background section hereof, inline spectrophotometers used to proof a digital document reproduction device and offline spectrophotometers used to measure test patches printed by that device have spectral differences which arise, in part from differences in their instrumentation. Instrument differences between inline and offline instruments (or between two inline instruments) can make output colors inconsistent with expectations even when the spot color calibration or profiling technology employed does an excellent job. Instrument optics, viewing geometry, photometry, electronics, speed of measurement, illumination size, detection, resolution, etc., contribute to measurement differences between the two. Differences can be wavelength dependent. Not only are there differences between different types/models of spectral sensing devices but there can be differences in performance even among members of a class of instruments. Hence, in order to provide good spot color matching or profiling to meet customer expectations, differences between spectral measurement instruments need to be accounted for. The teachings hereof are directed to compensating for spectral differences between the inline sensors used by the printer for device color control and the offline instruments used to characterize the reference and/or output samples.

The primary spectrophotometer errors which are typically found in commercial instrumentation are: gain, offset, and wavelength shift. A gain-offset-wavelength shift (GOW) compensation method is disclosed herein to correct errors between instruments using measurements obtained from only a few printed test patches. A Robust Q-matrix method is also disclosed but this method requires more patches than the GOW method. Workflows are presented which can be applied to spot color reproduction and printer profiling. These workflows require only a few compensation samples to be measured by the offline instrumentation thereby minimizing user effort. Since there could potentially be hundreds of spot colors that might be of interest to the customer, this is a significant benefit. This is even more important for profiling, where thousands of colors may need to be measured.

The teachings hereof are useful in a variety of diverse applications where spectral measurements for color consistency control functions are important. The disclosed embodiments are useful in numerous technologies and manufacturing applications where differences exist between two or more reflectance measurement systems used in such applications. Examples include: textiles, wallpaper, plastics, paint, inks, fabrics, dyes, etc. Different reflectance sensing devices may be part of a direct feedback color control system, an automated color correction system, or a color sampling system for regular or random quality control testing. As discussed herein further, performance results using the teachings herein show a significant reduction between instrumentation differences.

### Example Digital Document Reproduction Device

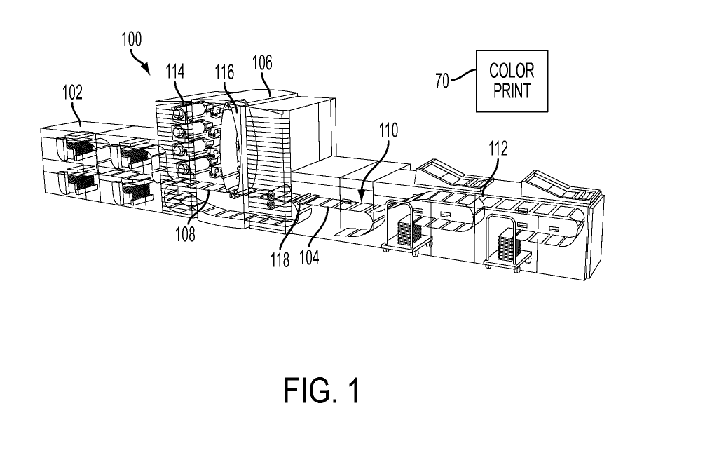

Reference is now briefly being made to FIG. 1 which shows an example digital document reproduction system which includes an inline spectrophotometer. Digital document reproduction device 100 includes a source 102 of print media 104. The paper is fed to marking engine 106 along paper path 108. Upon printing, the print media travels output path 110 to finisher 112. The marking engine is an N-color engine having a plurality of imaging/development subsystems 114 for producing color images on photoreceptor 116 in the form of a belt. The belt transfers the images to the print media 104, shown as sheets of paper. First spectral sensor 118 measures spectral reflectance values on paper 104. A second spectral sensor (not shown) is an offline sensor used to measure spectral reflectance values on output color print 70. While the printing system is described as having four color separations (C, M, Y and K), it should be appreciated that fewer or more color separations may be employed.

### Example Spectral Reflectance Measurement Device

One embodiment of a spectral reflectance measurement sensing device is shown in prior art FIGS. 4 and 5. Spectrophotometer 402 is one example spectral reflectance measurement sensing device shown having 8 illuminators D1, D2, . . . D8, (collectively at 414) each having a different color spectrum. The spectrophotometer is suited to non-contact measurement of colored target areas which are sequentially angularly illuminated with multiple different colors. The example spectrophotometer provides non-contact color measurements of moving color target areas variably displaced there from within normal paper-path baffle spacings. In this embodiment, there are eight illuminators tightly clustered in the center of the device which shine straight upward. There are six photodetectors mounted in a circle around the perimeter of the device which detect light reflecting from the color test patch 431 at a 45° angle. Color filters for the illuminators may be utilized to control the spectral range. Such color filters are often used to exclude secondary emissions and/or to further narrow the output spectra of an illumination source. The different color emission light sources are positioned in one central unit, board, or chip. The plurality of different color emission illuminators sequentially project their illuminations substantially in parallel, perpendicular to the surface of the test target rather than at an angle so as to provide a substantially circular illuminated area rather than one that is elliptical. A substantially circular illumination pattern is formed from respective light rays hitting the surface at a substantially normal angle of incidence. This produces a substantially circular pattern of irradiance on the target. The normal target area is an area of a color test patch 431 printed on sheet 430 and traveling in direction 440. Each illuminator has a lens 413 for focusing the light from each respective light source onto the reflectance sensing device. Although conventional glass or plastic lenses are illustrated, it will be appreciated that fiber optics could be utilized in the alternative to collect the light and to space the reflectance sensing device away from the light source.

Illumination of the test target provides a variable level of light reflected from the target surface. The sensors are oriented at 45° to the target to receive the reflected light. The resulting voltage signal is integrated. The integrated voltage is a function of reflectance. The voltages are then normalized using, for example, a white tile calibration which is standard in the color measurement industry. Normalized voltages are converted to spectral reflectance values using spectral reconstruction matrices to generate a fully populated reflectance spectrum. The relative reflectance of each actuated illuminator's wavelength may be measured using conventional circuitry and/or software capable of amplifying and integrating the respective outputs of the photosensors, which has integral sample-and-hold circuitry capable of sampling reasonably-sized color test patches on a normal size sheet moving past the sensors. The example spectral measurement sensing device of FIGS. 4 and 5 can be employed in either of an inline or offline configuration.

### Flow Diagram of One Example Embodiment

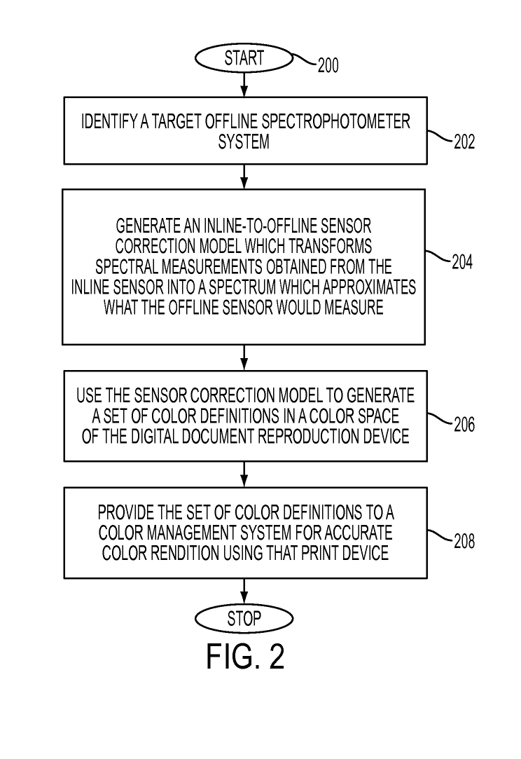

Reference is now being made to the flow diagram of FIG. 2 which illustrates one example embodiment of the present method for compensating for differences between an inline spectrophotometer and an offline spectrophotometer to perform accurate color management in a digital document reproduction system. The method starts at step 200 and immediately proceeds to step 202. Although this embodiment is shown and discussed with respect to a digital document reproduction system wherein the first spectral reflectance measurement sensor is an inline device, i.e., in the paper path, and the second spectral reflectance measurement sensor is an off-line device, i.e., external to the print system device, it should be appreciated that both sensors may be inline to the print system or both may be offline devices.

At step 202, a spectral reflectance measurement sensor is identified as a target sensing device.

At step 204 a first-to-second sensor correction model is generated which transforms spectral measurements obtained from the first sensor into a spectrum approximating what the second sensor would measure. The sensor correction model, in one embodiment, comprises a sensor correction matrix determined by either a least squares or a robust least squares method, as is known in the art. The sensor correction matrix may be constrained to a sparse matrix. In the instance wherein the print system is calibrated according to a spot color calibration, the sensor correction model is determined according to a spot color workflow discussed herein. In the instance where the calibration is a device profiling operation, the sensor correction model is determined according to a process color workflow discussed herein.

At step 206, the sensor correction model is used to generate a set of color definitions in a color space of the digital document reproduction device.

At step 208, the set of color definitions is provided to the digital document reproduction device such that, when color patches are printed by that device and measured by the target offline sensor, differences between the target reflectance spectra and spectral measurements from the offline sensor fall within a predetermined level of acceptable tolerance. The sensor correction matrix and/or the set of color definitions may be stored to a memory or storage device or communicated to a remote device over a network. Thereafter, further processing in this embodiment ends.

It should be understood that the flow diagrams depicted herein are illustrative. One or more of the operations illustrated in any of the flow diagrams may be performed in a different order. Other operations may be added, modified, enhanced, condensed, integrated, or consolidated. Variations thereof are intended to fall within the scope of the appended claims. All or portions of the flow diagrams may be implemented partially or fully in hardware in conjunction with machine executable instructions in communication with various components of such a system.

### Process Color Workflow

One embodiment of a customer workflow for printer profiling is as follows: An instrument compensation workflow, described herein, is performed by the user. This step may be performed once or repeated as needed. At most, this step would be conducted every time the printer is profiled, but could be done less frequently. Since profiling is typically conducted infrequently (at intervals of several days or weeks) the imposition on the user is limited. The compensation step is specific to the particular printer (actually to the inline sensor used in the printer) and to the user's offline instrumentation. As part of the instrument compensation workflow, a specific set of color patches is printed and measured by the first inline sensor. This patch set may be very small, depending on the compensation method. It could be a few patches selected from the large patch set used for profiling. An example of a commonly used profiling patch set is the IT8.7/4, which contains 1617 color patches. In contrast, the smallest number of patches needed for correlation is just 3, though in practice a somewhat larger correlation patch set might be used for robustness to noise. The small patch set is then measured by the user using the desired target offline instrumentation. The resulting reflectance spectra are transmitted to the operating software which could be part of a profiling facility. Virtually all spectrophotometers provide a computer interface for transmitting spectra. However, if a very low-end instrument is used which does not provide this capability, the data may be entered manually since only a few samples are needed. The profiling facility would take the offline and inline spectral reflectance measurements for the patch set and generate a transform. One embodiment of a suitable transform is a correlation matrix. When measuring the profiling patch set, the correlation matrix is used to transform each spectral color measurement from the inline instrument into a spectrum approximating what the offline instrument would measure. A set of transformed color (L*a*b*) values would be calculated from each of these spectra. The printer destination profile would then be generated from the transformed color values, rather than from the color values of the profiling patch set directly measured by the inline instrumentation. The net result is that the profile generated is a close approximation of a profile which would be generated using the offline instrument, rather than the inline instrument (ILS). Since the offline instrument represents ‘truth’ to a user, this outcome is important where, for example, the success of the color management is judged entirely by the offline instrument without regard to inline instrument's results. On the other hand, all of the benefits of ILS measurement (fully automatic, no user intervention) are preserved.

### Spot Color Calibration Workflow

One embodiment of a customer workflow for spot color calibration is as follows. Some steps are the same as those in the printer profiling workflow. An instrument compensation workflow, described herein, is performed by the user. This may be performed once or repeated at defined intervals. A good time to do this would be when profiling the print system device. As part of the instrument compensation step, a specific set of color patches is (automatically) printed and measured by the inline sensor. This patch set may be very small depending on the compensation method used. For simplicity, it could be a few patches selected from the large patch set used for profiling. An example of a commonly used profiling patch set is the IT8.714, which contains 1617 color patches. In contrast, the smallest number of patches needed for correlation is just 3, although in practice, a somewhat larger correlation patch set might be used, for robustness to noise. The small patch set is then measured by the user using the desired offline instrumentation. The resulting reflectance spectra are transmitted to the operating software, which could be part of the profiling facility. The profiling facility would take the offline and inline spectra for the patch set and generate a correlation matrix. When conducting a spot color calibration (e.g., ASCE), the inverse correlation matrix would be used to modify the incoming offline spectra measured on any reference hardcopy samples by the user. All of this is transparent to the user. The net result is that the spot color recipe produces spot colors which measure very close to the target L*a*b* values when measured by the offline instrument, rather than by the ILS. Since only the offline instrument represents a true match as far as the user is concerned without any regard to ILS results, this outcome is critically important. On the other hand, all of the benefits of ILS measurement (fully automatic, no user intervention) are preserved, without which this would be a laborious iterative process for the user.

### Instrument Compensation Workflow

Two methods for instrument-to-instrument compensation are next discussed. One method is the Robust Q-matrix Method and the other is the Gain-Offset-Wavelength shift (GOW) method which addresses three errors typically found in commercial spectrophotometer instruments in terms of physical models: gain, offset, and wavelength shift. The GOW method is preferred as wavelength-dependent gain and offset are commonly encountered due to calibration errors, instrumentation differences, differences in optics, etc. Wavelength shift can occur in the popular grating-type sensors due to optical misregistration between the grating and the detector array. Such errors are common even in high-end commercial devices. Differences between individual units of a given model may be larger than the errors between different models. Since these errors may change with time even for a given instrument due to wear, dirt, and the like, periodic re-compensation is required.

### Sensor Correction Model: Matrix Method

One convenient form of an inter-instrument transform is a correlation matrix comprising a 31×31 matrix. That is, given the reflectance measurement, Rⱼ⁽¹⁾(λ) λ=400, 410, . . . , 700, of a patch j using sensor #1 and the reflectance measurement of the same patch using sensor #2, i.e., Rⱼ⁽²⁾(λ), one can correlate the two measurements by a matrix Q:

Rⱼ⁽¹⁾(λ)=Q·Rⱼ⁽¹²⁾(λ) (1)

To identify the correction matrix Q, reflectance measurement of at least 31 test patches from both instruments is required, since Q has 31 rows. In practice, it is preferred to have much more than 31 test samples to solve Q robustly against measurement noises, printer noises, etc. When the number of test samples is more than 31, the matrix Q can be solved via matrix pseudo-inverse. (See the above-incorporated reference “Imaging Colorimetry Using a Digital Camera” for more details). Depending on the noise level of the measurement and printing, it generally requires hundreds of patches to yield a reliable Q matrix. Hence a “robust Q-matrix” is generally used instead.

### Robust Q-Matrix Method

This compensation method may require less patches than a regular Q-matrix method discussed above while still requiring significantly more patches than the GOW method to be discussed below. The key idea here as opposed to the regular Q-matrix method above is to pre-process the measured data for noise reduction and thus provide a more robust estimate of Q-matrix with fewer or same amount of test samples. A well-known technique for noise reduction pre-processing is to use Principal Component Analysis (PCA) to reduce the data dimension to N (less than 31 in this case). In this application, the smallest N is chosen such that 95% of the energy of the original measurements can be represented by N PCA bases. When N=31, 100% of the energy of the original measurements is represented by PCA bases but there is no reduction of dimension. Thus, this method is reduced to a regular Q-matrix method if N=31.

### Sparse Q-Matrix Method

This compensation method requires significantly less patches than regular or robust Q-matrix methods require due to its sparseness. In the limiting case, one would only need M samples to find a sparse Q-matrix that has M independent variables. The challenge is to identify a reasonable structure (or set of constraints) that is appropriate for correcting the inter-instrument difference for this particular task. Hence the robustness and correction capability of this method relies heavily on the choice of the structure of the sparse Q-matrix. One structure of this sparse Q-matrix is presented herein and is derived from a GOW (gain, offset, and wavelength shift) model. That is, the sparse Q-matrix is limited to have only three independent variables: gain given by: a₁(λ), offset given by: a₀(λ), and wavelength-shift given by: Δλ. In one embodiment, this is given by:

$${R}_{j}^{( 1 )} ( λ ) = [ \begin{matrix}{a}_{1} ( 400 ) \cdot ( 1 - \frac{Δ λ}{10} ) & \frac{Δ λ}{10} & 0 & & 0 \\ \frac{- Δ λ}{20} & {a}_{1} ( 410 ) & \frac{Δ λ}{20} & ⋱ & \\ 0 & \frac{- Δ λ}{20} & ⋱ & {a}_{1} ( 690 ) & \frac{Δ λ}{20} \\ 0 & & & \frac{- Δ λ}{10} & {a}_{1} ( 700 ) \cdot ( 1 + \frac{Δ λ}{10} )\end{matrix} ] . \\ {R}_{j}^{( 2 )} ( λ ) + [ \begin{matrix}{a}_{0} ( 400 ) \\ ⋮ \\ {a}_{0} ( 700 )\end{matrix} ] . \qquad ( 2 )$$

Note that the GOW sparse Q-matrix has mostly zeros except the diagonal, first upper and lower off-diagonal terms, and an offset vector a₀(λ). This model needs as few as three test samples to find the sparse Q-matrix.

Here the gain-offset parameters a₁'s and a₀'s are solved using linear least-square-error fitting on measurements of two or more color patches (preferably including black and white samples).

To estimate Δλ, one or more color patches (preferably including chromatic samples) are measured and this relationship is applied:

$$[ \begin{matrix}{R}_{j}^{( 1 )} ( 410 ) - {R}_{j}^{( 2 )} ( 410 ) \\ ⋮ \\ {R}_{j}^{( 1 )} ( 690 ) - {R}_{j}^{( 2 )} ( 690 )\end{matrix} ] = [ \begin{matrix}( \frac{{R}_{j}^{( 1 )} ( 420 ) - {R}_{j}^{( 2 )} ( 400 )}{20} ) \\ ⋮ \\ ( \frac{{R}_{j}^{( 1 )} ( 700 ) - {R}_{j}^{( 2 )} ( 680 )}{20} )\end{matrix} ] \cdot Δ λ . \qquad ( 3 )$$

The theoretical basis and the derivation of the above equations will be discussed shortly.

### Gain Offset Wavelength Shift (GOW) Model

This compensation method can generally be described by the following relationship:

R_{ILS}(λ)=a₀(λ)+a₁(λ)Rᵤ(λ)+a₂\dot{R}ᵤ(λ)+a₃(λ)\ddot{R}ᵤ(λ), (4)

where, R_{ILS}(λ) is the transformed reflectance spectrum of a given color, Rᵤ(λ) is the reflectance spectrum of that color measured by the offline instrument, \dot{R}ᵤ(λ) and \ddot{R}ᵤ(λ) are the first and second derivatives of the offline reflectance spectrum with respect to wavelength, a₀(λ) is the scaling for zero/black offset, a₁(λ) is the white point scaling, a₂(λ) is the wavelength scaling, and a₃(λ) is the bandwidth scaling. It can be shown that the wavelength correction is not strictly confined to the a₂(λ) parameter. This is a first-order approximation of a power series which includes higher-order derivatives beyond \dot{R}ᵤ(λ), and is valid for small wavelength errors. Higher-order terms may be included, if desired, for more accurate compensation. With these theoretical models in mind, we now derive a sparse Q-matrix based on a GOW model.

### Derivation of the Sparse Q-Matrix Based on GOW Model

### Gain Offset Model:

One method for correcting instrument-to-instrument differences is to derive and apply wavelength-dependent gain and offset terms in Eq. (4) to the measured reflectance. That is, assuming that the reflectance measured by the reference instrument #1, i.e., R⁽¹⁾(λ), can be approximated from the measurement of the target instrument #2, i.e., R⁽²⁾(λ), using an approximation given by:

R⁽¹⁾(λ)≈a₀(λ)+a₁(λ)·R⁽²⁾(λ) (5)

Sampling λ from 400 nm to 700 nm with 10 nm spacing, Eq. (5) can be formulated as follows:

$${R}^{( 1 )} ( 400 ) \approx {a}_{0} ( 400 ) + {a}_{1} ( 400 ) \cdot {R}^{( 2 )} ( 400 ) \\ {R}^{( 1 )} ( 410 ) \approx {a}_{0} ( 410 ) + {a}_{1} ( 410 ) \cdot {R}^{( 2 )} ( 410 ) \\ {R}^{( 1 )} ( 420 ) \approx {a}_{0} ( 420 ) + {a}_{1} ( 420 ) \cdot {R}^{( 2 )} ( 420 ) \\ … \\ {R}^{( 1 )} ( 700 ) \approx {a}_{0} ( 700 ) + {a}_{1} ( 700 ) \cdot {R}^{( 2 )} ( 700 ) \qquad ( 6 )$$

This can also represented in matrix form given by:

$$[ \begin{matrix}{R}^{( 1 )} ( 400 ) \\ ⋮ \\ {R}^{( 1 )} ( 700 )\end{matrix} ] = [ \begin{matrix}{a}_{1} ( 400 ) & 0 & & 0 \\ 0 & {a}_{1} ( 410 ) & & \\ & 0 & ⋱ & \\ 0 & & 0 & {a}_{1} ( 700 )\end{matrix} ] [ \begin{matrix}{R}^{( 2 )} ( 400 ) \\ ⋮ \\ {R}^{( 2 )} ( 700 )\end{matrix} ] + [ \begin{matrix}{a}_{0} ( 400 ) \\ ⋮ \\ {a}_{0} ( 700 )\end{matrix} ] . \qquad ( 7 )$$

The a₀'s and a₁'s are solved by a linear least squares error fit between measurements of instrument #1 and instrument #2.

### Wavelength-Shift Model:

One other cause of instrument-to-instrument difference can be characterized by a wavelength shift (e.g. grating misalignment).

Let f(λ) be the “true reflectance of a color patch. Assume that instrument #1 is properly measured that, i.e., R⁽¹⁾(λ)=f(λ).

Let R⁽²⁾(λ) be instrument #2 which does not properly measure f(λ) due to wavelength shift, i.e., R⁽²⁾(λ)=f(λ−Δλ).

Then, to correct this wavelength error on a measurement from R⁽²⁾(λ), one can use the following derivation:

$${R}^{( 1 )} ( λ ) = f ( λ ) \\ {R}^{( 1 )} ( λ ) = f ( λ - Δ λ ) + ( f ( λ ) - f ( λ - Δ λ ) ) \\ {R}^{( 1 )} ( λ ) \approx {R}^{( 2 )} ( λ ) + ( {f}^{′} ( λ - Δ λ ) \cdot Δ λ + \frac{{f}^{″} ( λ - Δ λ )}{2} \cdot {( Δ λ )}^{2} + … ) \\ {R}^{( 1 )} ( λ ) = {R}^{( 2 )} ( λ ) + ( \frac{d {R}^{( 2 )} ( λ )}{d λ} \cdot Δ λ + \frac{{d}^{2} {R}^{( 2 )} ( λ )}{2 {( d λ )}^{2}} \cdot {( Δ λ )}^{2} + … ) \qquad ( 8 )$$

To correct the instrument-to-instrument differences due to a constant wavelength shift, the 1^{st} order approximation of Eq. (8) can be used, given by:

$${R}^{( 1 )} ( λ ) \approx {R}^{( 2 )} ( λ ) + ( \frac{d {R}^{( 2 )} ( λ )}{d λ} \cdot Δ λ ) \qquad ( 9 )$$

Further approximating the first derivative:

$$\frac{d {R}^{( 2 )} ( λ )}{d λ} \approx \frac{( {R}^{( 2 )} ( λ + d λ ) - {R}^{( 2 )} ( λ - d λ ) )}{2 d λ}$$

and sampling λ from 400 nm to 700 nm with 10 nm spacing, Eq. (9) can be formulated as follows:

(Boundary Case)

$${R}^{( 1 )} ( 400 ) \approx {R}^{( 2 )} ( 400 ) + ( \frac{{R}^{( 2 )} ( 410 ) - {R}^{( 2 )} ( 400 )}{10} ) \cdot Δ λ \\ {R}^{( 1 )} ( 410 ) \approx {R}^{( 2 )} ( 410 ) + ( \frac{{R}^{( 2 )} ( 420 ) - {R}^{( 2 )} ( 400 )}{20} ) \cdot Δ λ \\ {R}^{( 1 )} ( 420 ) \approx {R}^{( 2 )} ( 420 ) + ( \frac{{R}^{( 2 )} ( 430 ) - {R}^{( 2 )} ( 410 )}{20} ) \cdot Δ λ \\ … \\ {R}^{( 1 )} ( 700 ) \approx {R}^{( 2 )} ( 700 ) + ( \frac{{R}^{( 2 )} ( 700 ) - {R}^{( 2 )} ( 690 )}{10} ) \cdot Δ λ \qquad ( 10 )$$

In a matrix form:

$$[ \begin{matrix}{R}^{( 1 )} ( 400 ) \\ ⋮ \\ {R}^{( 1 )} ( 700 )\end{matrix} ] = [ \begin{matrix}( 1 - \frac{Δ λ}{10} ) & \frac{Δ λ}{10} & 0 & & 0 \\ \frac{- Δ λ}{20} & 1 & \frac{Δ λ}{20} & ⋱ & \\ 0 & \frac{- Δ λ}{20} & ⋱ & 1 & \frac{Δ λ}{20} \\ 0 & & & \frac{- Δ λ}{10} & ( 1 + \frac{Δ λ}{10} )\end{matrix} ] \cdot [ \begin{matrix}{R}^{( 2 )} ( 400 ) \\ ⋮ \\ {R}^{( 2 )} ( 700 )\end{matrix} ] . \qquad ( 11 )$$

This shows that a sparse 31×31 matrix with a non-zero diagonal+two off-diagonal entries is sufficient to correct the instrument-to-instrument difference due to constant wavelength error. Moreover, the sparse matrix is quite structured, i.e., it is almost symmetric in the opposite sides of diagonal except at the boundary. One skilled in this art would appreciate that this can be used as a constraint to obtain a robust derivation of the correction matrix. One can also use a higher numerical approximation of f′(λ).

To estimate Δλ, one can measure a color (or a set of colors) and then use all relationships in Eq. (10), or use only the non-boundary equations, such that:

$$[ \begin{matrix}{R}_{j}^{( 1 )} ( 410 ) - {R}_{j}^{( 2 )} ( 410 ) \\ ⋮ \\ {R}_{j}^{( 1 )} ( 690 ) - {R}_{j}^{( 2 )} ( 690 )\end{matrix} ] = [ \begin{matrix}( \frac{{R}_{j}^{( 1 )} ( 420 ) - {R}_{j}^{( 2 )} ( 400 )}{20} ) \\ ⋮ \\ ( \frac{{R}_{j}^{( 1 )} ( 700 ) - {R}_{j}^{( 2 )} ( 680 )}{20} )\end{matrix} ] \cdot Δ λ . \qquad ( 12 )$$

The following describes how Eq. (3) is derived.

### Combining Gain, Offset and Wavelength-Shift

By combining GOW Eq. (7) & (11), a (near-diagonal) correlation matrix can be generated, given by:

$${R}_{j}^{( 1 )} ( λ ) = [ \begin{matrix}{a}_{1} ( 400 ) \cdot ( 1 - \frac{Δλ}{10} ) & \frac{Δ λ}{10} & 0 & & 0 \\ \frac{- Δ λ}{20} & {a}_{1} ( 410 ) & \frac{Δ λ}{20} & ⋱ & \\ 0 & \frac{- Δ λ}{20} & ⋱ & {a}_{1} ( 690 ) & \frac{Δ λ}{20} \\ 0 & & ⋱ & \frac{- Δ λ}{10} & {a}_{1} ( 700 ) \cdot ( 1 + \frac{Δ λ}{10} )\end{matrix} ] . \\ {R}_{j}^{( 2 )} ( λ ) + [ \begin{matrix}{a}_{0} ( 400 ) \\ ⋮ \\ {a}_{0} ( 700 )\end{matrix} ] , \qquad ( 13 )$$

where the gain-offset parameters a₁'s and a₀'s are solved using linear least-square-errors fitting (ideally with black and white samples) and the wavelength shift Δλ is solved using Eq. (12) (ideally with a chromatic sample such as red, green, or blue).

Although the GOW model provides a good foundation for a reasonable structure for sparse Q-matrix, it may not be ideal in some cases where, for example, the wavelength shift is not equal across all wavelengths in the reflectance measurements between the two sensors. To deal with that, one can numerically solve the above Q-matrix by assuming that the non-zero terms are only at the diagonal, two off-diagonals, and offset, without using Eq. (2) & (3). This would allow great flexibility when the GOW model is slightly violated while retaining the structure (and robustness) of the sparse Q-matrix.

### Performance Results

A test was conducted on 8 spectrophotometers (4 XRite DTP-70 devices and 4 Gretag Spectrolino devices). One DTP-70 was randomly picked as a reference and the remaining 7 devices were used as testing instruments. In this test, just three printed color patches of a printer [White (0,0,0,0) Black (100,100,100,100), and Red (0,100,100,0)] were first measured with all 8 spectrophotometers. Model parameters were derived for correcting instrument-to-instrument errors relative to the reference DTP-70. An IT8.7/3 target (928 cmyk patches) was then measured with all 8 spectrophotometers as the testing set of these model parameters. Color errors (dE2000) relative to the reference instrument without and with model correction were calculated. The results from the GOW (gain+offset+wavelength correction) method are shown in Table 1. As shown, the present method reduced instrument-to-instrument differences, even when using only three color patches.

TABLE 1

| SPM | ave | P95 | max |
|---|---|---|---|
| D2 | 1.01 | 3.01 | 4.26 |
| D3 | 0.34 | 0.55 | 1.03 |
| D4 | 0.34 | 0.55 | 1.03 |
| S1 | 0.91 | 1.84 | 2.36 |
| S2 | 0.62 | 1.27 | 2.09 |
| S3 | 0.81 | 1.64 | 2.42 |
| S4 | 0.43 | 0.74 | 1.12 |

TABLE 2

| SPM | ave | P95 | max |
|---|---|---|---|
| D2 | 0.74 | 1.63 | 2.19 |
| D3 | 0.29 | 0.65 | 1.03 |
| D4 | 0.26 | 0.60 | 0.98 |
| S1 | 0.42 | 1.04 | 1.75 |
| S2 | 0.39 | 0.81 | 1.66 |
| S3 | 0.42 | 0.98 | 1.73 |
| S4 | 0.38 | 0.86 | 1.54 |

The Robust Q-matrix Method was also evaluated. Principal Component Analysis (PCA) was used to reduce the dimensionality of a full 31×31 matrix to 7×31, by using 7 basis vectors. Obviously, the Robust Q-matrix cannot be used with just the three patches so a 350 patch TP45 target was used as the training set. The results are shown in Table 3. In spite of the larger training set, this approach did not perform as well as the GOW method.

TABLE 3

| SPM | ave | P95 | max |
|---|---|---|---|
| D2 | 0.87 | 1.94 | 2.79 |
| D3 | 0.33 | 0.63 | 0.90 |
| D4 | 0.45 | 0.70 | 0.88 |
| S1 | 0.68 | 1.25 | 2.15 |
| S2 | 0.50 | 0.92 | 1.76 |
| S3 | 0.51 | 0.93 | 1.37 |
| S4 | 0.59 | 1.31 | 2.28 |

### Example Special Purpose Computer

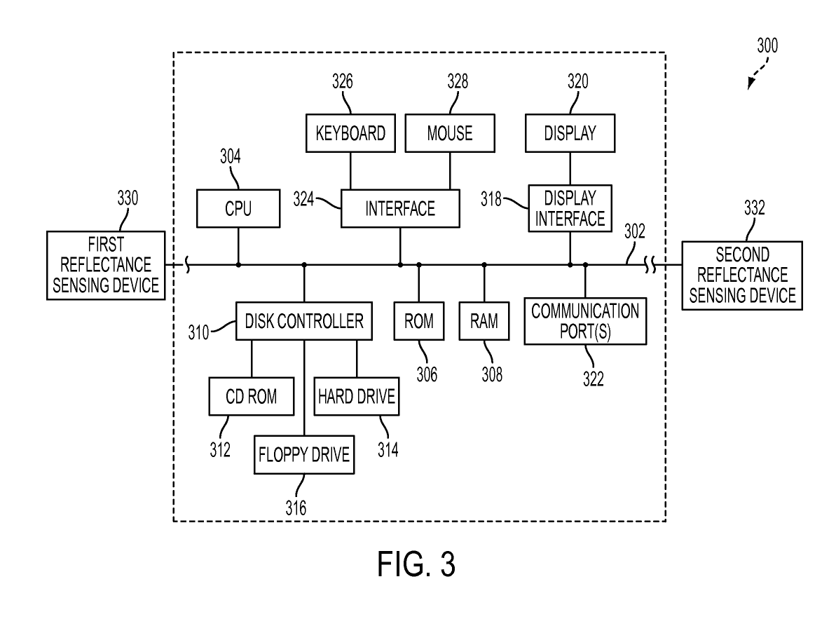

Reference is now being made to FIG. 3 which illustrates a block diagram of one example embodiment of a special purpose computer system for performing one or more aspects of the present system and method as described with respect to the example flow diagram of FIG. 2. Such a special purpose system is capable of executing machine readable program instructions for carrying out one or more aspects of the present method and may comprise any of a micro-processor or micro-controller, ASIC, electronic circuit, or special purpose computer system. Such a system can be integrated, in whole or in part, with a xerographic system and/or a color management system. All or portions of the flow diagram of FIG. 2 may be implemented partially or fully in hardware in conjunction with machine executable instructions in communication with various components of such a system.

The special purpose computer system of FIG. 3 incorporates a central processing unit (CPU) 304 capable of executing machine readable program instructions for performing any of the calculations, comparisons, logical operations, and other program instructions for performing the methods described above with respect to the flow diagrams hereof. The CPU is in communication with Read Only Memory (ROM) 306 and Random Access Memory (RAM) 308 which, collectively, constitute example memory storage devices. Such memory may be used to store machine readable program instructions and other program data and results to sufficient to carry out any of the functionality described herein. Disk controller 310 interfaces with one or more storage devices 314 which may comprise external memory, zip drives, flash memory, USB drives, memory sticks, or other storage devices with removable media such as CD-ROM drive 312 and floppy drive 316. Computer readable media is, for example, a floppy disk, a hard-drive, memory, CD-ROM, DVD, tape, cassette, or other digital or analog media, or the like, which is capable of having embodied thereon a computer readable program, one or more logical instructions, or other machine executable codes or commands that implement and facilitate the function, capability, and methodologies described herein. Computer programs may be stored in a main memory and/or a secondary memory. Computer programs may also be received via the communications interface. The computer readable medium is further capable of storing data, machine instructions, message packets, or other machine readable information, and may include non-volatile memory. Such computer programs, when executed, enable the computer system to perform one or more aspects of the methods provided herein.

Display interface 318 effectuates the display of information on display device 320 in various formats such as, for instance, audio, graphic, text, and the like. Interface 324 effectuates a communication via keyboard 326 and mouse 328. A graphical user interface is useful for a user to review information or for entering information. Communication with external devices may occur using example communication port(s) 322. Example communication ports include modems, network cards such as an Ethernet card, routers, a PCMCIA slot and card, USB ports, and the like, capable of transferring data from one device to another. Software and data transferred via the communication ports 322 are in the form of signals which may be any of digital, analog, electromagnetic, optical, infrared, or other signals capable of being transmitted and/or received by the communications interface. Such signals may be implemented using, for example, a wire, cable, fiber optic, phone line, cellular link, RF, or other signal transmission means presently known in the arts or which have been subsequently developed.

Also shown in the embodiment of FIG. 3 are first and second spectral reflectance measurement sensing devices 330 and 332, respectively. The CPU 304 is in communication with each sensing device and receives measurement data and device parameters and characteristics therefrom and stores such values to memory 306 and 308 and storage device 314 via disk controller 310. In the above-described workflows, measurements obtained by the first (inline) sensor 330 are used as part of the instrument compensation step. A small set of test patches are then measured using the second (offline) target reflectance sensing device. The resulting reflectance spectra are transmitted to the CPU for processing. The CPU executes machine readable program instructions stored in memory 306 and/or 308 to generate a correlation matrix which transforms each spectral color measurement from the inline sensor 330 into a spectrum approximating what the offline sensor 332 would measure. A set of transformed color (L*a*b*) values are calculated from these spectra. The correlation matrix is stored. A user may enter values for any of the computations hereof using keyboard 326 and mouse 328. The transformed color values would be used to generate a printer destination profile which is communicated to the document reproduction system via communication port 322. The net result in the profiling workflow is that the profile generated is a close approximation of a profile which would be generated using the offline instrument 332 rather than the inline instrument 330. The net result is that the spot color calibration workflow is that the spot color recipe produce spot colors which measure very close to the target Lab values when measured by the offline instrument 332, rather than by the inline instrument 330.

Various modules described herein with respect to FIG. 3 may designate one or more components which may, in turn, each comprise software and/or hardware designed to perform a specific function. A plurality of modules may collectively perform a single function. A module may have a specialized processor capable of reading machine executable program instructions. A module may comprise a single piece of hardware such as an ASIC, electronic circuit, or special purpose processor. A plurality of modules may be executed by either a single special purpose computer system or a plurality of special purpose computer systems in parallel. Connections between modules includes both physical and logical connections. Modules may include software/hardware modules which may comprise an operating system, drivers, controllers, and other apparatuses, some or all of which may be connected via a network.

It is also contemplated that one or more aspects of the present method may be practiced in distributed computing environments where tasks are performed by remote processing devices that are linked through a communication network. In a distributed computing environment, program modules for performing various aspects of the present system and method. Other embodiments include a special purpose computer designed to perform the methods disclosed herein. The methods described can be implemented on a special purpose computer, a micro-processor or micro-controller, an ASIC or other integrated circuit, a DSP, an electronic circuit such as a discrete element circuit, a programmable device such as a PLD, PLA, FPGA, PAL, PDA, and the like. The teachings hereof can be implemented in hardware or software using any known or later developed systems, structures, devices, and/or software by those skilled in the applicable art without undue experimentation from the functional description provided herein with a general knowledge of the relevant arts. Moreover, the methods hereof may be readily implemented as software executed on a programmed general purpose computer, a special purpose computer, a microprocessor, or the like.

One or more aspects of the methods described herein are intended to be incorporated in an article of manufacture, including one or more computer program products, having computer usable or machine readable media. For purposes hereof, a computer usable or machine readable media is, for example, a floppy disk, a hard-drive, memory, CD-ROM, DVD, tape, cassette, or other digital or analog media, or the like, which is capable of having embodied thereon a computer readable program, one or more logical instructions, or other machine executable codes or commands that implement and facilitate the function, capability, and methodologies described herein. Furthermore, the article of manufacture may be included on at least one storage device readable by a machine architecture or other xerographic or image processing system embodying executable program instructions capable of performing the methodology described in the flow diagrams. Additionally, the article of manufacture may be included as part of a xerographic system, an operating system, a plug-in, or may be shipped, sold, leased, or otherwise provided separately, either alone or as part of an add-on, update, upgrade, or product suite.

It will be appreciated that various of the above-disclosed and other features and functions, or alternatives thereof, may be desirably combined into many other different systems or applications. Various presently unforeseen or unanticipated alternatives, modifications, variations, or improvements therein may become apparent and/or subsequently made by those skilled in the art, which are also intended to be encompassed by the following claims. Accordingly, the embodiments set forth above are considered to be illustrative and not limiting. Changes to the above-described embodiments may be made without departing from the spirit and scope of the invention. The teachings of any printed publications including patents and patent applications, are each separately hereby incorporated by reference in their entirety.

What is claimed is:

1. A method for performing color management on a digital color printing system incorporating an inline spectral reflectance measurement sensor, the method comprising:
generating at least one print on said digital color printing system incorporating an inline spectral reflectance measurement sensor;
measuring spectral reflectance of said print using said inline spectral reflectance measurement sensor;
measuring spectral reflectance of said print using a selected offline spectral reflectance measurement sensor;
determining, from said measurements, a sensor correction model which transforms spectral measurements obtained from said inline sensor into spectra approximating what said offline sensor would measure; and
using said sensor correction model to perform color management on said digital color printing system such that print output of said digital color printing system is accurate when measured on said offline sensor.

2. The method of claim 1, wherein said sensor correction model is a matrix.

3. The method of claim 2, wherein said matrix comprises a sensor correction matrix constrained to a sparse matrix.

4. The method of claim 2, wherein said sensor correction matrix is determined by any of: a least squares methodology, and a robust least squares methodology.

5. The method of claim 1, wherein performing said color management on said digital color printing system comprises generating any of: a profile, and a spot color recipe.

6. The method of claim 1, wherein said color management is performed using reflectance spectra which are modified from spectral reflectance of print samples measured using said inline sensor.

7. The method of claim 6, wherein said modified spectra are obtained by taking the product of said sensor correction model and said spectral reflectance measured using said inline sensor.

8. The method of claim 1, wherein said at least one print comprises colors which include at least white, black and chromatic colors.

9. A system for performing color management on a digital color printing system incorporating an inline spectral reflectance measurement sensor, the system comprising:
a memory and a storage device; and
a processor in communication with said memory and said storage, said processor executing machine readable instructions which, when executed perform a method comprising:
generating at least one print on said digital color printing system incorporating an inline spectral reflectance measurement sensor;
measuring spectral reflectance of said print using said inline spectral reflectance measurement sensor;
measuring spectral reflectance of said print using a selected offline spectral reflectance measurement sensor;
determining, from said measurements, a sensor correction model which transforms spectral measurements obtained from said inline sensor into spectra approximating what said offline sensor would measure; and
using said sensor correction model to perform color management on said digital color printing system such that print output of said digital color printing system is accurate when measured on said offline sensor.

10. The system of claim 9, wherein said sensor correction model is a matrix.

11. The system of claim 10, wherein said matrix comprises a sensor correction matrix constrained to a sparse matrix.

12. The system of claim 10, wherein said sensor correction matrix is determined by any of: a least squares methodology, and a robust least squares methodology.

13. The system of claim 9, wherein performing said color management comprises generating any of: a profile, and a spot color recipe.

14. The system of claim 9, wherein said color management is performed using reflectance spectra which are modified from spectral reflectance of print samples measured using said first spectral reflectance measurement sensor.

15. The system of claim 14, wherein said modified spectra are obtained by taking the product of said sensor correction model and said spectral reflectance measured using said first spectral reflectance measurement sensor.

16. A computer implemented method for performing color management on a digital color printing system incorporating an inline spectral reflectance measurement sensor, comprising:
generating at least one print on said digital color printing system incorporating an inline spectral reflectance measurement sensor;
measuring spectral reflectance of said print using said inline spectral reflectance measurement sensor;
measuring spectral reflectance of said print using a selected offline spectral reflectance measurement sensor;
determining, from said measurements, a sensor correction model which transforms spectral measurements obtained from said inline sensor into spectra approximating what said offline sensor would measure; and
using said sensor correction model to perform color management on said digital color printing system such that print output of said digital color printing system is accurate when measured on said offline sensor.

17. The computer implemented method of claim 16, wherein said sensor correction model is a matrix.

18. The computer implemented method of claim 17, wherein said matrix comprises a sensor correction matrix constrained to a sparse matrix.

19. The computer implemented method of claim 17, wherein said sensor correction matrix is determined by any of: a least squares methodology, and a robust least squares methodology.

20. The computer implemented method of claim 16, wherein performing said color management comprises generating any of: a profile, and a spot color recipe.

21. The computer implemented method of claim 16, wherein said color management is performed using reflectance spectra which are modified from spectral reflectance of print samples measured using said first spectral reflectance measurement sensor.

22. The computer implemented method of claim 21, wherein said modified spectra are obtained by taking the product of said sensor correction model and said spectral reflectance measured using said first spectral reflectance measurement sensor.
